(19) United States
(12) Patent Application Publication
(10) Pub. No.: US 2010/0332296 A1
(43) Pub. Date: Dec. 30, 2010

(54) SYSTEMS, METHODS, AND COMPUTER-READABLE MEDIA FOR COMMUNITY REVIEW OF ITEMS IN AN ELECTRONIC STORE

(75) Inventor: Sam Gharabally, San Francisco, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/492,100

(22) Filed: Jun. 25, 2009

(51) Int. Cl. G06Q 30/00

(52) U.S. Cl. 705/14.2

(57) ABSTRACT

Disclosed herein are systems, computer-implemented methods, and tangible computer-readable media for community-based ranking in an electronic store. The method includes receiving a predictive ranking of an item in an electronic store and feedback about the item from each of a group of individuals, the predictive ranking being predictive of item performance in the electronic store. The method further tracks an actual ranking of the item over time based on item performance in the electronic store, provides an incentive for individuals in the group of individuals whose associated predictive ranking coincides with the actual ranking of the item, and presents in the electronic store received feedback from at least one individual associated with the predictive ranking that coincides with the actual ranking of the item. Rankings can be directed to different subdomains in the electronic or online store. Individuals having favorable successful prediction ratios can receive incentives.

### BACKGROUND OF THE INVENTION

1. Field of the Invention

The present invention relates to electronic commerce and more specifically to using the collective wisdom of a community to predict rankings for items for sale in an electronic store.

2. Introduction

Online electronic stores are becoming more and more common. Online stores can be directed to the general public or to owners of specific devices. These online stores offer a variety of items in order to serve the needs of as many potential customers as possible. These items can include media files, applications, books, etc. Item quality can vary widely. Popular taste also varies widely. Some items of only standard quality can become extremely successful while other outstanding items go unnoticed. Often these online stores do not offer adequate preview mechanisms for these items so potential customers do not know if a particular item will fit their needs and wants.

An example perhaps best illustrates this problem. Consider Jane, a small business owner, who is looking for a mobile accounting program that can sync with her small business accounting program. Jane browses the online store and finds three different applications that purport to meet these requirements. However, Jane is uncomfortable paying for one without knowing if it will really do what she wants it to do. In order to mitigate this uncertainty and increase sales, the online store operator can hire testers to review each application in the online store, but this approach can be time-intensive and cost-prohibitive, especially with software applications having different editions and each edition has versions with different subsets of functionality. Additionally, the online store operator may not be aware of some key customer requirements, such as Jane's need for syncing with a desktop application. The online store can allow software publishers to review their own software, but their opinions will be biased. The online store can invite anyone to review items in the store, but these reviews have very little meaning without some way for customers to know if the reviewers are trustworthy.

What is needed in online stores is an improved way to allow customers like Jane to feel confident in their online store purchases without the need for hiring expensive testers or reviewers.

### SUMMARY

Additional features and advantages of the invention are set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed herein are systems, computer-implemented methods, and tangible computer-readable media for community-based predictive ranking of items in an electronic store. The method includes receiving a preliminary predictive ranking of an item in an electronic store and feedback about the item from each of a group of individuals. The predictive ranking is predictive of item performance in the electronic store. The method further tracks via a processor an actual ranking of the item over time based on item performance in the electronic store, provides an incentive for individuals in the group of individuals whose associated predictive ranking coincides with the actual ranking of the item, and presents in the electronic store received feedback from at least one individual whose predictive ranking coincides with the actual ranking of the item. Rankings can be directed to different item or customer subdomains in the electronic or online store. Individuals having favorable successful prediction ratios can receive incentives.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example predictive ranking history for applications;

FIG. 3 illustrates an example predictive ranking credibility and compensation table;

FIG. 4 illustrates a sample online store for gathering feedback and rankings from reviewers;

FIG. 5 illustrates an exemplary method embodiment; and

FIG. 6 illustrates an exemplary user interface for reviewing and predictively ranking audio files.

### DETAILED DESCRIPTION

Various embodiments of the invention are discussed in detail below. While specific implementations are discussed, this is done for illustration purposes only. A person skilled in the relevant art will recognize that other components and configurations may be used without parting from the spirit and scope of the invention.

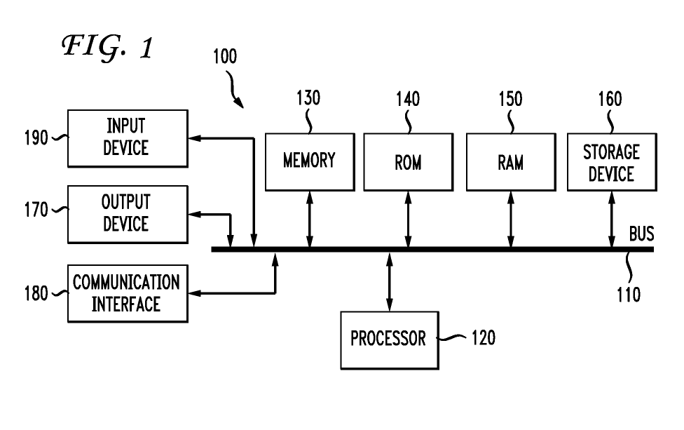

With reference to FIG. 1, an exemplary system includes a general-purpose computing device 100, with a processing unit (CPU) 120 and a system bus 110 that couples system components such as read-only memory (ROM) 140, random access memory (RAM) 150, and other system memory 130 to the CPU 120. The invention may operate on a computing device with more than one core or CPU 120 or on a group of connected computing devices. A CPU 120 can include a general purpose CPU controlled by software as well as a special-purpose processor. Of course, a processing unit includes any general purpose CPU and a module configured to control the CPU as well as a special-purpose processor where software, functionality, or instructions are effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer-readable media provide nonvolatile storage of computer-readable instructions, data structures, and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs a hard disk, it should be appreciated by those skilled in the art that other types of tangible and intangible computer-readable media which can store data that are accessible by a computer, such as flash memory cards, DVDs, random access memories (RAMs), read-only memory (ROM), a cable or wireless signal containing a bit stream and the like, may also be used in the exemplary operating environment. Tangible computer-readable media expressly exclude media such as energy, carrier signals, electromagnetic waves.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment includes individual functional blocks (including functional blocks labeled as a “processor”). The functions these blocks represent may be provided through the use of either shared or dedicated hardware, including, but not limited to, hardware capable of executing software or modules configured to control the processor to perform certain steps and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments can include microprocessor and/or digital signal processor (DSP) hardware, read-only memory (ROM) for storing software performing the operations discussed below or controlling the processor to perform the steps, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

Having disclosed some fundamental system components, the disclosure turns to a more detailed description of the method embodiments. For clarity, the methods are discussed in terms of a system operating with a processor configured to practice the method. The following examples are illustrative and should not be considered limiting as the principles described can be incorporated in other embodiments and configurations. These steps can be performed by a system with a processor that performs the steps of the method.

We return for a moment to Jane who is searching for a mobile accounting software package. Jane searches an online electronic store having applications for her mobile device and finds five applications that claim to have the features she needs. The promotional information provided by each manufacturer gushes about how fantastic each application is. In order to sort out which one best suits Jane's needs, she must do extensive research to find unbiased information if the online store does not aid her. Often, if Jane is researching online she must browse away from the online store and may decide to purchase the accounting application from another vendor. It is in the interest of the online store to provide as much information as possible for Jane so that she can make an informed decision and purchase the software from the store and not elsewhere. One way to approach this problem is to allow individuals to review applications for functionality, ease of use, safety, speed, accuracy, and/or various other criteria. If the electronic store delegates this task to a large group of users, or “crowdsources” the task, it will save money which would otherwise pay for full-time staff reviewers. The problem with this approach is that not every reviewer is as trustworthy as the other and customers end up frustrated because they must spend a long time sorting through reviews to determine which ones are sufficiently detailed, unbiased, well-written, and otherwise generally useful. The online store can provide a credibility or trustworthiness score for reviewers based on some metric. An aspect of this disclosure is to provide a mechanism of identifying quality reviewers by their ability to accurately predict the sales performance of an item in the online store prior to actual sales and/or availability of ranking data.

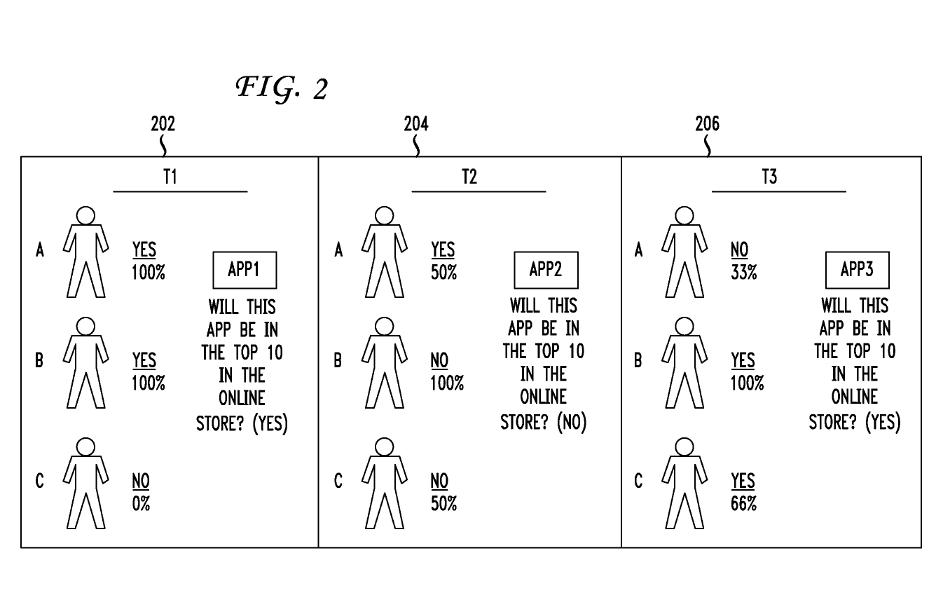

FIG. 2 illustrates an example predictive ranking history for applications. In this example, three persons labeled A, B, and C, are reviewers for the electronic store. At time T1 202, the reviewers submit their predictions for the question “Will App1 be in the top 10 in the online store?” The reviewers have an opportunity to download and test or use all or part of the application. In this manner, the reviewers can provide an intelligent prediction of its ranking. In this example, once the application is actually sold through the online store, its ranking was high. Thus, the answer to the question is yes, indicating that it will at a later point in time be in the top 10 in the store. A and B correctly predict yes and C incorrectly predicts no. The electronic store assigns 1/1 or 100% credibility to A and B and 0/1 or 0% credibility to C.

Next, at time T2 204, the reviewers submit their predictions for the question “Will App2 be in the top 10 in the online store?” In this example, the eventual answer to this question is no, indicating that it will not be in the top 10 in the store at a later point in time. B and C correctly predict no and C incorrectly predicts yes. The electronic store assigns 2/2 or 100% credibility to B, ½ or 50% credibility to A and C.

Next, at time T3 206, the reviewers submit their predictions for the question “Will App3 be in the top 10 in the online store?” In this example, the objective answer to this question is yes, indicating that it will be in the top 10 in the store at a later point in time. B correctly predicts yes and A and C incorrectly predict no. The electronic store assigns 3/3 or 100% credibility to B, ⅓ or 33% credibility to A, and ⅔ or 66% credibility to C. In this way, a history of successful predictions will lead to a higher credibility score.

In one aspect, each prediction can be weighted based on difficulty in prediction or based on other criteria. For example, if an extremely popular musician who has had multiple top 10 albums releases a new album, then a successful prediction of an expected result can be worth less. As another example, if a completely unknown musician with no previously released albums releases a new album, then a successful prediction of an expected result can be worth more. Such weights can be determined manually, automatically, or by some combination of both. There are many variations for measuring credibility. One variation tracks only successful predictive rankings. In this manner, a reviewer's credibility is shown as “over 100 successful predictions” or “over 2,500 successful predictions”, allowing customers of the electronic store, like Jane mentioned above, to judge for themselves what those credibility scores mean and how much trust to assign. Jane can be more confident reading a review from B discussing accounting software she is considering than reading a review from A.

In some situations, an electronic store's offer of an increased credibility score is not enough to motivate sufficient numbers of individuals to review products. An electronic store can also offer cash incentives to successful reviewers. Monetary incentives are not integral to the invention and other tangible or intangible incentives can be substituted, such as credibility points, exclusive media (such as songs, photos, user icons, etc.), and others.

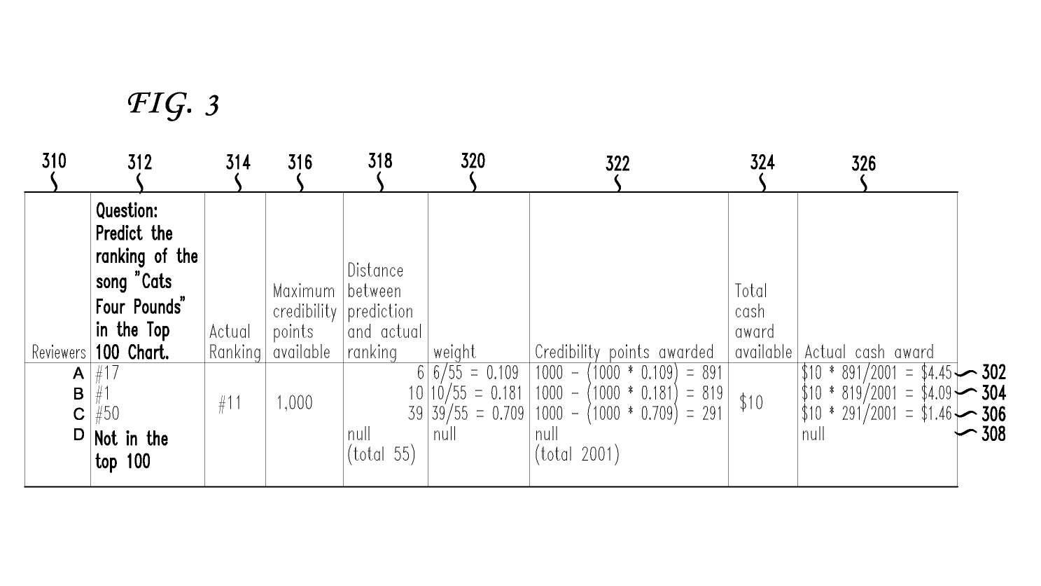

FIG. 3 illustrates an example predictive ranking credibility and compensation table. The steps outlined in this example are non-limiting. This example shows four reviewers 310, A 302, B 304, C 306, and D 308. Each reviewer, after sampling the media in question, makes a prediction of its maximum chart position 312. The sampled media can include audio, video, still pictures, software application, websites, games, and so forth. A predicts that the sampled media will reach number 17, B predicts number 1, C predicts number 50, and D predicts that it will not even break in to the top 100 chart. The actual ranking of the song 314 based on sales performance in the online store is 11^{th} place. The system can measure actual performance based on sales in the online store, one or more external source (such as the Billboard Top 100 list), some other metric(s), or a combination thereof. A combination of metrics can be weighted or unweighted.

In one variation, the system determines the maximum number of credibility points 316 for this prediction and bases the awarded credibility points on how close to correct each prediction is. For example, the system can calculate a weight 320 based on the distance between the predicted ranking and the actual ranking 318. This chart shows that the weight is calculated by dividing the distance between the predictive ranking and the actual ranking by the sum of all the distances, 55 in this example. Other suitable mechanisms exist for calculating the weight. The system can determine the amount of credibility points based on the weight 322. The example here shows that awarded credibility points are calculated by subtracting the maximum credibility points multiplied by the weight from the maximum credibility points.

Further, the system can provide an actual cash award 324 for reviewers. In some cases, the media producer (i.e. a singer, artist, software publisher, and so forth) provides all or part of the cash award to generate promotional interest in their item in the online store. In other cases, the electronic store can provide all or part of the cash award as a cheaper alternative to hiring full-time reviewers. An electronic store can provide an equivalent to a cash award in the form of store credit or gift cards to the online store. In yet other cases, a portion of advertising revenue provides all or part of the cash award. The award can be based on the amount of advertising revenue associated with a review or ranking. In this example, the total cash award 324 is $10. The cash award can be based on assigned credibility points. To determine the actual cash award for each reviewer, this example multiplies the total cash award by the individual reviewer's awarded credibility points divided by the total awarded credibility points. The electronic store can use other distribution/compensation algorithms. In this chart, reviewer B 304 predicted the song “Cats Four Pounds” would be #1. It was actually #11, a difference of 10 chart positions. The sum of predictive distances for the four reviewers is 55 chart positions, i.e. A's prediction was 6 chart positions off, B's prediction was 10 chart positions off, and C's prediction was 39 chart positions off, for a total of 55 chart positions. The predictive weight for the ranking of reviewer B is 10/55 or 0.181. The system awards 819 credibility points by calculating 1000−(1000*0.181). The total number of credibility points awarded to A, B, and C in this example is 2001. The system calculates B's actual cash award of $4.09 as $10*(819/2001). The shown chart and calculations should be considered non-limiting and only demonstrate one possible approach among many for distributing credibility points, cash awards, and/or other incentives. One possible way to encourage accurate predictions or to reduce prediction inflation is to provide asymmetric incentives and disincentives for going over or under the actual ranking. For example, if the actual chart position is 10, the award for underpredicting chart position 15 can be greater than the award for overpredicting chart position 5. In this example, the weights are based on the collective performance of all a group of reviewers. The system can assign weights without relying on other reviewers.

Often a global ranking in an online store is not very meaningful to customers. In the example of Jane who is searching for mobile accounting software, she is not so interested in how a particular mobile accounting package ranks compared to a VoIP application or a 3D game. For this reason, the system can allow reviewers to predict rankings within a subdomain of the electronic store, such as accounting or medical software. With song media, subdomains can include different genres such as Country, Pop, and Eastern European Folk Music. Subdomains can include categories of users, such as teenagers or attorneys. The online store can allow for varying levels of granularity when defining subdomains. One item in the online store can be part of multiple subdomains. One reviewer can provide multiple rankings and/or reviews for a single item but for different subdomains. For example, a reviewer can predict that a particular puzzle game in an online application store will be in the top 50 overall chart, will be in the top 5 of the games subdomain, and will be the number 1 for teens aged 13-18. The reviewer can also provide different reviews associated with each ranking prediction, each review being targeted to the expected interests of a particular subdomain.

The system can assign higher credibility and/or precedence to reviewers based on the number of correct predictions and how long the reviewer has participated as a reviewer. Along with varying levels of credibility and/or precedence, the system can form a hierarchy or different tiers of reviewers. The hierarchy can be based on a threshold of a number or percentage of correct review predictions, customer feedback, or other factors. The system can separate reviewers into paid and non-paid tiers, where non-paid reviewers must first qualify to join the paid tier.

In some cases, higher credibility can lead to amplified incentives. For example, if a reviewer has made 10 correct predictions in a row, then the system can grant a double incentive for each consecutive prediction beyond those 10.

In one aspect, the system can select customers at random to review items in the online store. For example, each day, the system can select 10 customers to review 3 items. The system can select customers at random from the general customer base or randomly from a more targeted group of customers. The system can assign all 10 of the customers the same items to review or the item selection can also be at random. The system or administrators of the system can balance the needs for informed reviewers and unbiased reviewers when selecting reviewers and items to be reviewed. In some instances, reviewers can also predict the item's placement in the navigation structure of the online store, or under what tab the item will be available.

The timing of reviews is important. Earlier correct reviews can be more valuable. In one aspect, reviewers have available a limited amount of information, perhaps representing a trend. For instance, if an application in the online store has been on sale for one week and has had a meteoric 40% increase in sales day over day, the system can ask a reviewer how many weeks she expects the trend to continue. Based on the amount of available data, the system can assign the prediction more or less weight.

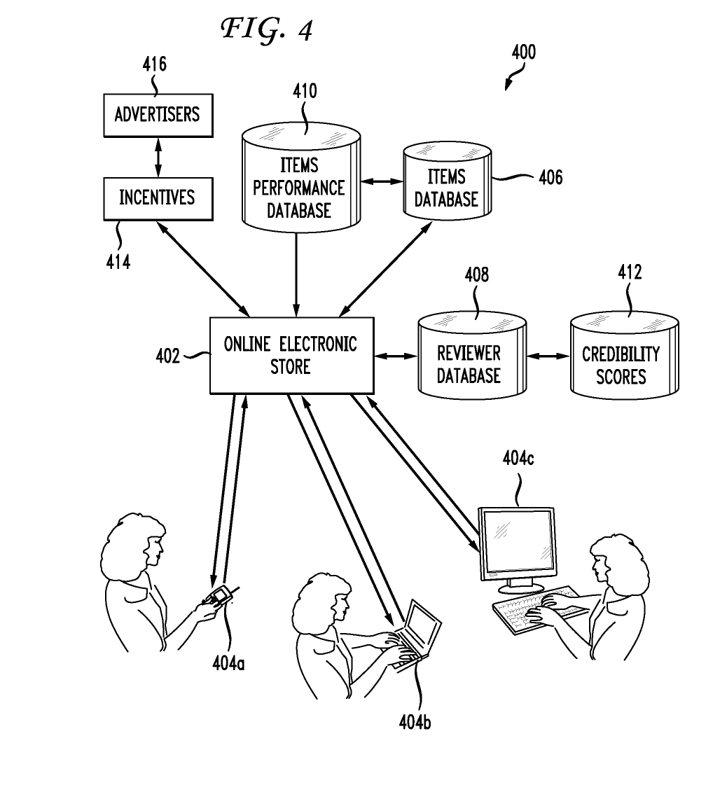

FIG. 4 illustrates a sample online store for gathering feedback and rankings from reviewers 400. The online store 402 can notify users 404a, 404b, 404c that an item is available for review. Would-be reviewers can request to review a specific item in the online store 402. Users can interact with the online store wirelessly with mobile devices, with laptop computers, desktop computers, or with any other suitable computing device over any type of wired or wireless data connection. The online store retrieves the item or a sample of the item to be reviewed from an items database 406. The online store 402 can decide the amount and form of the item to be reviewed based on the type of item. For example, if the item is a song, the store can deliver the entire song, a 60-second full quality sample, a reduced quality sample of the entire song, etc. If the item is an application, the store can deliver the entire application, a full-featured version of the application set to expire after 7 days, or a limited functionality version of the application, etc. The online store can suitably adapt other items for review.

Once the reviewers receive the item to review from the online store 402, they can use or sample the item. Reviewers can then use their judgment to predict a ranking for the item in the online store and provide a review or feedback. The ranking can be as simple as a chart or sales position. The ranking can be tied to a specific time frame, such as a reviewer predicting that the item will be in the top 10 chart for at least 5 consecutive weeks. The review can be somewhat more detailed, with a description of features, ease of use, speed, performance, accuracy, etc. The reviewers transmit their predictive ranking and reviews to the online store 402 which stores them in a reviewer database 408.

The online store tracks item performance in the store using an items performance database 410. The items performance database can include a complete snapshot of chart position and sales history for each item in the store on some regular schedule so as to be able to reconstruct, for example, daily sales in the online store for any given day. When predictions in the reviewer database 408 match or substantially match an item's actual performance in the performance database 410, the system can provide an incentive 414. One unique type of incentive is a credibility score 412. As a particular reviewer makes a series of successful predictions, the online store can increase that reviewer's credibility score. Other incentives can include money, credit in the electronic or online store, an increased experience score, access to restricted content, free or discounted entry into a contest or sweepstakes, the reviewed item, and a service. The system can provide other incentives as well. In some cases, advertisers 416 provide incentives 414 for successful reviews. The online store can even share advertising revenue generated at least in part due to the ranking and/or review. Any of these incentives can be dependent on certain qualifications based on or established by the predictive ranking, feedback, the reviewer, the item, the electronic store, additional customer feedback, or any combination thereof. Conversely, when a reviewer submits unsuccessful reviews, the online store 402 can decrease the reviewer's credibility score 412 and/or provide other disincentives.

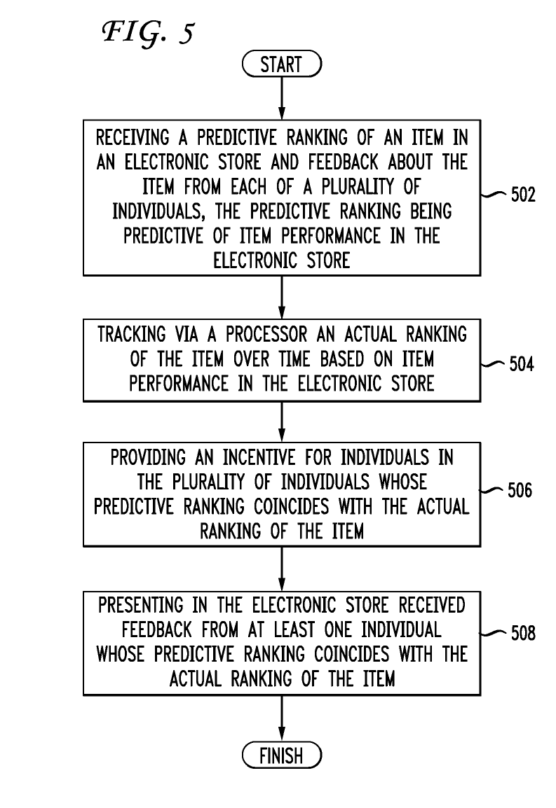

FIG. 5 illustrates an exemplary method embodiment for community-based ranking in an electronic store. For clarity, the method is discussed in terms of a system configured to practice the method. One or more system processor can perform any or all of the outlined steps.

The system receives a predictive ranking of an item in an electronic store and feedback about the item from each of a group of individuals, the ranking being predictive of objective item performance in the electronic store (502). A received ranking can predict a sales ranking within the electronic store generally or by a specified date. The predictive ranking can predict a chart position based on sales within a geographic region or based on third-party sales rankings. The online store can select the group of individuals at random or based on a previously established credibility score. The group of individuals can represent a specific subsegment of a community. The subsegment can be based on demographics, previously purchased items, personal profile information, item categories, etc. The item in the electronic store can be one or more of an application, audio file, video file, document, data set, developer tool, subscription, or service from a service provider.

The system tracks via a processor an actual ranking of the item over time based on item performance in the electronic store (504). The system provides an incentive for individuals in the group of individuals whose predictive ranking coincides with the actual ranking of the item (506). The incentive can be at least one of money, electronic store credit, an increased credibility score, an increased experience score, access to restricted content, free or discounted entry into a contest, the reviewed item, a service, or other incentive. If the incentive is a credibility score, the store can divide individuals into a hierarchy based on a credibility score. In some situations, the system provides incentives for only a limited subset of the group of individuals, perhaps based on the hierarchy. If the incentive is money or cash, advertising revenue can provide at least a portion of the incentive. Multiple incentive levels can correspond to how well the actual performance based ranking of the item coincides with the predictive ranking. In one aspect, the system also provides a disincentive for unsuccessful predictions, i.e. individuals whose associated predictive ranking does not coincide with the actual ranking of the item after a predetermined time. Such a disincentive can include withdrawal of electronic store credit, a decreased credibility score, a decreased experience score, and/or revoked access to restricted content.

The system presents in the electronic store received feedback from at least one individual whose predictive ranking coincides with the actual ranking of the item (508). The system can further prominently feature feedback from individuals who satisfy a threshold of success in predictive rankings that coincide with actual item rankings. Customers and shoppers of the electronic store can select feedback to display from a subset of the group of individuals. For example, if a particular reviewer earns renown for prediction prowess and accurate critical reviews, customers can select reviews and predictions from that reviewer as having priority over others. In order to enable this feature, the system can store a ranking success history for each individual in the group of individuals. The history can include ranking predictions as well as more in-depth reviews and feedback. Customers of the online store can gain access to all of the data about a particular reviewer, including a complete review and predictive ranking history.

In one variation, the system further generates a predictive index for the item based on aggregated rankings from a subgroup from the group of individuals and presents the generated predictive index with the item in the electronic store. In this way, the wisdom and collective prediction of a group can provide a quick and easy to understand indication of expected success of the item in the online store. In another variation, online store customers can become “followers” of a certain reviewer. The online store can notify followers when the certain reviewer has posted a new review. As a reviewer gains followers, the online store can increase his or her status and credibility. In one aspect, followers can provide meta-predictions of how the reviewer's predictions will fare. Reviewers with greater numbers of followers can enjoy preferred status, such as the ability to review more objects, more compensation, and/or other benefits.

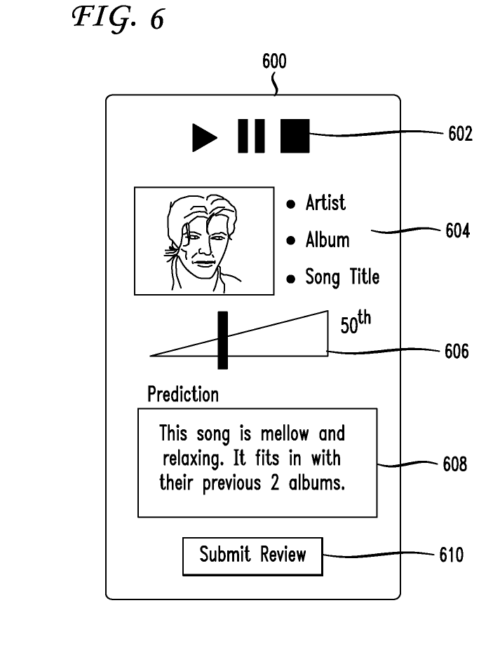

FIG. 6 illustrates an exemplary user interface for reviewing and predictively ranking audio files on a mobile device display 600. The user can interact with the display by touch, stylus, keyboard, mouse, buttons, speech, or other human interface devices. The exemplary user interface can be adapted for use on other devices as well. The user interface provides playback controls 602 to allow the user to play, pause, and stop playback. Other standard controls, such as fast forward or rewind can also be included. While it is not shown, the interface can also include a progress bar showing the playback position of the song. The interface can display album media, artist name, album name, and song title 604 as well as other available metadata. As the song is playing or after the song is done playing, the interface can allow the user to indicate a predicted ranking of the song on the chart. The interface in this example is a slider bar 606. In some cases, multiple slider bars can allow the reviewer to predict multiple different aspects. If a user desires to make no prediction, the user can, for example, slide the slider all the way to the left. In one aspect, as the user slides the slider, the number to the right of the bar updates in real time to provide feedback for the predicted position. The interface can include a textbox 608 for the user to provide written comments or a review of the song. In some cases, the text entered in a textbox can be substituted with other inputs, such as a spoken review. When the reviewer is done with the prediction and the review, he or she can click the submit review button 610 or provide other suitable input indicating that he or she is finished.

The user interface can also display to the user individual or aggregated predictions and/or reviews from others. The user interface can show others' predictions at any point in the process. For example, the reviewer can see what others are predicting in real time as he or she is listening to the song. In another variation, the reviewer can see others' reviews and predictions only after submitting their own, so as not to taint his or her own review and prediction. The system can show a standard deviation or other metric indicating the submitted prediction's position relative to a group of predictions.

In one aspect, the system favors successful or popular reviewers by offering those reviewers more items to review or by offering items to review earlier. In this way, the online store can get a preliminary indication of potentially successful items and devote extra resources to promote those items. Extra resources can include, among other things, advertising, links, discounts, direct messages to potential customers, and promotional placement in the online store.

Embodiments within the scope of the present invention may also include tangible or intangible computer-readable media for carrying or having computer-executable instructions or data structures stored thereon. Tangible computer-readable storage media expressly exclude, for example, transient transmission signals, electromagnetic waves, and signals per se. Such computer-readable media can be any available media that can be accessed by a general purpose or special purpose computer, including the functional design of any special purpose processor as discussed above. Some non-limiting examples of such tangible computer-readable storage media are RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above are also within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, data structures, objects, components, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles disclosed herein are applicable to online stores selling electronic media, software applications, services, and any combination thereof. As new technologies emerge, those of skill in the art will appreciate how to easily modify the principles herein to accommodate the differences and additional features of new categories of items in electronic stores. Those skilled in the art will readily recognize various modifications and changes that may be made to the present invention without following the example embodiments and applications illustrated and described herein, and without departing from the true spirit and scope of the present invention.

I claim:

1. A computer-implemented method of community-based ranking in an electronic store, the method comprising:
receiving a predictive ranking of an item in an electronic store and feedback about the item from each of a plurality of individuals, the predictive ranking being predictive of item performance in the electronic store;
tracking via a processor an actual ranking of the item over time based on item performance in the electronic store;
providing an incentive for individuals in the plurality of individuals whose predictive ranking coincides with the actual ranking of the item; and
presenting in the electronic store received feedback from at least one individual whose predictive ranking coincides with the actual ranking of the item.

2. The computer-implemented method of claim 1, wherein the incentive comprises at least one of money, electronic store credit, an increased credibility score, an increased experience score, access to restricted content, free or discounted entry into a contest, the item, and a service.

3. The computer-implemented method of claim 2, the method further comprising providing the incentive only for a limited subset of the plurality of individuals.

4. The computer-implemented method of claim 1, the method further comprising displaying feedback from a subset of the plurality of individuals to shoppers at the electronic store.

5. The computer-implemented method of claim 1, the method further comprising providing a disincentive for individuals in the plurality of individuals whose predictive ranking does not coincide with the actual ranking of the item after a predetermined time.

6. The computer-implemented method of claim 5, wherein the disincentive comprises at least one of withdrawal of electronic store credit, a decreased credibility score, a decreased experience score, and revoked access to restricted content.

7. A system for community-based ranking in an electronic store, the system comprising:
a processor;
a module configure to control the processor to receive a predictive ranking of an item in an electronic store and feedback about the item from each of a plurality of individuals, the predictive ranking being predictive of item performance in the electronic store at a specified time;
a module configured to control the processor to track an actual ranking of the item at the specified time based on item performance in the electronic store;
a module configured to control the processor to provide an incentive for individuals in the plurality of individuals whose predictive ranking coincides with the actual ranking of the item; and
a module configured to control the processor to present in the electronic store received feedback from at least one individual whose predictive ranking coincides with the actual ranking of the item.

8. The system of claim 7, wherein the received ranking comprises a placement within the electronic store.

9. The system of claim 8, wherein the received ranking comprises a placement within the electronic store by a specified date.

10. The system of claim 7, the system further comprising a module configured to control the processor to select the plurality of individuals at random.

11. The system of claim 7, the system further comprising a module configured to control the processor to select the plurality of individuals based on a credibility score.

12 The system of claim 7, wherein the plurality of individuals represents a specific subsegment of a community.

13. The system of claim 7, wherein the plurality of individuals is divided into a hierarchy based on a credibility score.

14. A tangible computer-readable storage medium storing a computer program having instructions for controlling a computing device to perform community-based ranking in an electronic store, the instructions comprising:
receiving a predictive ranking of an item in an electronic store about the item from each of a plurality of individuals, the predictive ranking being predictive of item performance in the electronic store;
tracking an actual ranking of the item over time based on item performance in the electronic store;
providing an incentive for individuals in the plurality of individuals whose predictive ranking coincides with the actual ranking of the item; and
presenting in the electronic store received predictive rankings from at least one individual whose predictive ranking coincides with the actual ranking of the item.

15. The tangible computer-readable storage medium of claim 14, wherein the items in the electronic store comprise one or more of an application, audio file, video file, document, data set, developer tool, subscription, or service from a service provider.

16. The tangible computer-readable storage medium of claim 14, the instructions further comprising prominently featuring feedback from individuals who satisfy a threshold of success in predictive rankings that coincide with actual item rankings.

17. The tangible computer-readable storage medium of claim 16, wherein shoppers at the electronic store can select feedback to display from a subset of the plurality of individuals.

18. The tangible computer-readable storage medium of claim 14, the instructions further comprising:
generating a predictive index for the item based on aggregated rankings from a subgroup from the plurality of individuals; and
presenting the generated predictive index with the item in the electronic store.

19. The tangible computer-readable storage medium of claim 14, wherein multiple levels of incentives correspond to how well the actual ranking of the item coincides with the predictive ranking.

20. The tangible computer-readable storage medium of claim 14, the instructions further comprising storing a ranking success history for each individual in the plurality of individuals.
